(19) United States
(12) Patent Application Publication
(10) Pub. No.: US 2008/0036354 A1
(43) Pub. Date: Feb. 14, 2008

(54) EXTERNAL ELECTRODE FLUORESCENT LAMP WITH OPTIMIZED OPERATING EFFICIENCY

(76) Inventors: Martin Letz, Mainz (DE); Jorg H. Fechner, Mainz (DE); Brigitte Hueber, Schwandorf (DE); Franz Ott, Konnersreuth (DE)

Correspondence Address: TAYLOR & AUST, P.C., P.O. Box 560, 142. S Main Street, Avilla, IN, 46710, US

(21) Appl. No.: 11/836,936

(22) Filed: Aug. 10, 2007

(30) Foreign Application Priority Data
Aug. 11, 2006 (DE) DE102006037859.8
Aug. 11, 2006 (DE) DE102006039066.0

(51) Int. Cl. H01J 65/04

(52) U.S. Cl. 313/234; 501/11

(57) ABSTRACT

An EEFL-type fluorescent lamp for backlighting of displays or screens, whereby the encapsulating glass and/or a (partial) coating of the interior surface of the encapsulating glass are provided which possess a low work function Wₐ for the electrons of <6 eV, preferably <5 eV, more preferably 0 eV<Wₐ<5 eV, especially preferably 0 eV<Wₐ<4 eV, more especially preferably 0 eV<Wₐ<3 eV. This allows for the operating efficiency to be optimized and the firing voltage to be lowered.

### BACKGROUND OF THE INVENTION

1. Field of the Invention

The invention relates to an External Electrode Fluorescent Lamp (EEFL)-type fluorescent lamp with optimized operating efficiency.

2. Description of the Related Art

It is known that fluorescent lamps, generally includes thin-walled glass tubes that may be utilized for backlighting of Thin Film Transistor (TFT) flat screens. In a newer development, lamps to which electrical power is provided by way of alternating voltage are available for this application. These are the so-called EEFLs (External Electrode Fluorescent Lamps). In this type of lamp no metal electrodes extend through the glass. The glass serves as the dielectric which, for instance, is equipped with an outer metal cap, with an ionized gas such as mercury or an inert gas in the interior of the tube, thereby creating a capacitor through which electrical power in the form of alternating voltage can be provided. The glass serves not only as a dielectric in the capacitor, but the surface inside the glass tube forms the cathode.

Currently the same glasses are used for EEFL-type fluorescent lamps as for conventional fluorescent lamps, whereby for example the metal electrodes extend through the glass (such as CCFLs; cold cathode fluorescence lamp). For example, EEFL-type fluorescent lamps and their applications are described in international publications WO 2006/006831 A1 and WO 2006/011752 A1. These are however not optimized with regard to their operating efficiency. No statements are made regarding the glasses used.

Glasses for light devices having exterior electrodes are described in DE 20 2005 004 459 U1 whereby:

$$\frac{Tan δ}{{ɛ}^{′}} < 5 \times {10}^{- 4}$$

is to apply for the ratio from the angle tan δ and the relative permittivity. These glasses possess optimized dielectric characteristics.

What is needed in the art is more efficient fluorescent lamp having a reduced firing voltage.

### SUMMARY OF THE INVENTION

The inventors have observed that the operating efficiency of a fluorescent lamp is greatest and the firing voltage of the lamp is at its lowest, if the encapsulating glass of the lamp is modified so that it possesses or provides as great a probability as possible to emit secondary electrons when an inert gas ion is being neutralized there. Reference is also made to the so-called “Auger-neutralization” which is known especially for the neutralization of inert gas ions on metal surfaces.

Due to the fact that glasses represent insulators the probability for the emission of secondary ions is very low if an ion from the glass plasma is neutralized on the surface of the cathode. This results in a high firing voltage in fluorescent lamps. Based on the high firing voltage, high voltages must be used in the flat panel screen, which represents a safety risk. In addition, the efficiency diminishes since a lag time occurs during the half wave of the driving alternating voltage.

It is an objective of the present invention to avoid these problems, which are inherent in the current state of the art and to provide fluorescent lamps of the EEFL-type which do not possess the described disadvantages.

Surprisingly, it has now been established that EEFL-type fluorescent lamps have an especially high operating efficiency and at the same time as low as possible a firing voltage for the lamp when glasses and/or glass coatings of the present invention are utilized, which are capable, with a high level of probability, to emit secondary electrons. This probability can be expressed by the work function Wₐ for the electrons. The work function is the smallest energy that is required to release an electron from a non-charged solid body. Consequently, glasses and/or glass coatings are to be utilized in accordance with the present invention for which a lowest possible emission function Wₐ can be selected.

This objective is met by an EEFL-type fluorescent lamp for backlighting of displays or screens, including an encapsulating glass, such as when:
(1) the encapsulating glass possesses a low work function Wₐ for the electrons of <6 eV, preferably <5 eV, more preferably OeV<Wₐ<5 eV, especially preferably OeV<Wₐ<4 eV, more especially preferably OeV<Wₐ<3 eV, and contains at least one doping agent, selected from:
   group (a), including BaO, CaO, MgO, SrO, MgF₂, AlN, Al₂O₃ and/or Mg_{1-x-y}SrₓCa_{y}O in an amount in the range of 3 to 70 weight-%, especially preferably of 5 to 60 weight-%, more especially preferably of 10 to 60 weight-%;
      and/or
   from group (b) including La₂O₃, Bi₂O₃, BaO and/or PbO in an amount in the range of 3 to 80 weight-%, especially preferably of 5 to 75 weight-%, more especially preferably 10 to 65 weight-%.
      and/or
(2) the encapsulating glass includes at least a partial interior coating which has a low work function Wₐ for the electrons of <6 eV, preferably <5 eV, more preferably O eV<Wₐ<5 eV, especially preferably OeV<Wₐ<4 eV, more especially preferably OeV<Wₐ<3 eV, whereby the interior coating contains at least one doping agent, includes at least one doping agent selected from
   group (a), including BaO, CaO, MgO, SrO, MgF₂, AlN, Al₂O₃ and/or Mg_{1-x-y}SrₓCa_{y}O in an amount in the range of 3 to 70 weight-%, especially preferably of 5 to 60 weight-%, more especially preferably of 10 to 60 weight-%;
      and/or
   from group (b) including La₂O₃, BaO, Bi₂O₃ and/or PbO in an amount in the range of 3 to 80 weight-%, especially preferably of 5 to 75 weight-%, more especially preferably 10 to 65 weight-%.

According to the present invention very specialized glasses and/or coatings for glasses are made available which contain at least one doping agent, especially preferably a combination of several doping agents. This makes it possible for the utilized encapsulating glass and/or the interior coating of the encapsulating glass to provide an optimum operating efficiency of the EEFL-type fluorescent lamp due to the low work function Wₐ for the electrons. In addition, this allows for the firing voltage of the EEFL-type fluorescent lamp to be lowered to a low level.

The encapsulating glasses are not especially limited within the scope of the present invention, in as far as they are suitable for EEFL-type fluorescent lamps. In accordance with one embodiment of the present invention these base glasses have a low work function Wₐ for electrons. This is achieved by doping of the glasses with one or more doping agents which are selected from group (a) and/or (b). For example, earth alkali ions (group (a)) may be contained in a preferred minimum concentration of 3 weight-%, preferably 5 weight-%, particularly 10 weight-%. These are, for example, of BaO, CaO, MgO, SrO, MgF₂, and also Mg_{1-x-y}SrₓCa_{y}O. These can be utilized individually or in combination of two, three, four or more.

In addition to the aforementioned earth alkali ions aluminum compositions such as Al₂O₃ and/or AlN may be used in the inventive glasses. The preferred range in which these doping agents contribute to the desired low work function Wₐ of the encapsulating glass is approximately 3 to approximately 70 weight-%, particularly approximately 10 to approximately 60 weight-%.

Beyond this there is the possibility, either alternatively or additionally to incorporate heavy metals into the glasses (group (b)). This concerns, for example, a composition, of oxides, especially lanthanum, bismuth, barium and/or lead. These are particularly easily polarizable ions whereby the cloud of electrons can be easily shifted toward the core.

In accordance with the present invention at least a partial interior coating may be provided in the encapsulating glass according to an additional inventive variation which contains at least one doping agent, preferably a combination of group (a) and/or (b) described above. The ranges of the amount of the doping agents from group (a) are selected preferably in a range of approximately 3 to approximately 70 weight-%. The ranges of the amount of the doping agents from group (b) are selected preferably in a range of approximately 3 to approximately 80 weight-%. As already stated, the doping agents from group (a) and (b) may also be combined.

The coating of the encapsulating glass on the interior surface of the glass is preferably only a partial coating, particularly on selected areas of the encapsulating glass. Advantageously, the interior coating is provided only where ions of the gas, which is contained in the lamp, are discharged, in other words in and around the area where the metal contacts of the cathode of the fluorescent lamp are located.

The coating thicknesses for the interior coating of the EEFL-type fluorescent lamp are preferably in a range of approximately 0.3 nm to approximately 10 μm. The cited thickness can however clearly be lower or be exceeded in individual instances. In addition to the doping agent or agents, conventional additives can also be contained in the coating.

It is especially desirable if the sum of the amount of dopant from group (a) and group (b) that are present in the encapsulating glass has a lower limit of ≧15 weight-%, preferably ≧20 weight-%, more especially preferably ≧30 weight-% and an upper limit of ≦80 weight-%, preferably ≦75 weight-%, more especially preferably ≦70 weight-%. In the same manner it is especially desirable if the sum of the amount of dopant from group (a) and group (b) in the partial interior coating has a lower limit of ≧15 weight-%, preferably ≧20 weight-%, more especially preferably ≧30 weight-% and an upper limit of ≦80 weight-%, preferably ≦75 weight-%, more especially preferably ≦70 weight-%. This particularly facilitates attainment of the advantageous characteristics of the present invention.

In accordance with an embodiment of the present invention the production procedure for the interior coating of the utilized encapsulating glasses is not especially limited. Any coating procedure may be utilized. The coating process may be accomplished, for example, through sputtering, dipping of the encapsulating glass, spraying or baking on of the coating medium. For example, the coating can be accomplished by dipping into a sludge with a powder, which contains at least one of the described dopants or consists entirely of the doping agent.

In accordance with another embodiment of the present invention the variations described above can be utilized not only individually, but also in combination. In this combined variation the encapsulating glass of the EEFL-type fluorescent lamp, whose glass composition contains at least one of the doping agents selected from group (a) and/or (b) is additionally provided with a coating which contains, or consists of at least one of the indicated doping agents selected from group (a) and/or (b). Especially preferred combinations utilize two, three, four or more of the indicated doping agents.

The doping agents utilized in accordance with the present invention lead to a clear lowering of the work function Wₐ for the electrons in the glass composition and/or the coating of the encapsulating glass, to a value of <6 eV, preferably <5 eV, more preferably 0 eV<Wₐ<5 eV, especially preferably 0 eV<Wₐ<4 eV, more especially preferably 0 eV<Wₐ<3 eV. In dependence on the work function Wₐ the so-called secondary emission rate y can continue to be regulated. Accordingly, the encapsulating glasses and/or the interior coating of the encapsulating glasses include a composition having a high secondary electron emission rate y, causes, for example, Hg—, Xe—, Ne— and/or Ar-ions when being bombarded thereby. The secondary electron emission rate y is regulated, preferably by way of selecting the doping agents in suitable amounts, so that: y>0.01, especially preferred y>0.05, more especially preferred y>0.1 applies. By regulating the secondary electron emission rate y, the encapsulating glasses or their interior coatings for these encapsulating glasses for the application in EEFL-type fluorescent lamps can successfully be further optimized, so that the desired low emission function Wₐ for the electrons is maintained. For example, this can be achieved by different combinations of the doping agents listed above, and by modifying the amounts used.

Especially preferred for use in the present invention are glass compositions and/or coating mediums, which possess a high electronic density in the valence band. More especially preferred are, for example, coating materials having a large band gap, for example >4 eV, in order to also make a coating possible that results in a fluorescent color.

It has also been especially advantageous for the operation of an EEFL-type fluorescent lamp, if a gas mixture is used. Particularly preferred is an inert gas mixture consisting of two or more inert gases with and without mercury vapor. For example, gas mixtures with neon and/or helium and/or argon and/or Hg and suchlike. Particularly preferred are gas mixtures, which contain neon in the range of 10 to 99 vol.-% and the remainder in the form of other inert gases. The purpose of using a gas mixture is that a combination of especially suitable characteristics is created. Xenon, for example possesses excellent fluorescent characteristics, whereas neon, due to its great ionization energy, leads to a high secondary emission rate y, which has been recognized to be particularly advantageous according to the present invention.

The present invention also relates to the utilization of an encapsulating glass and/or a partial interior coating for applications where a low work function Wₐ is required. The low work function Wₐ for the electrons is <6 eV, preferably <5 eV, more preferably 0 eV<Wₐ<5 eV, especially preferably 0 eV<Wₐ<4 eV, more especially preferred 0 eV<Wₐ 3 eV, especially for EEFL-type fluorescent lamps, whereby the encapsulating glass or the (partial) interior coating contains at least one of the described doping agents in the suitable amounts.

The inventive EEFL-type fluorescent lamp, particularly a miniaturized fluorescent lamp, is used in particular in the area of background lighting or backlight systems of electronic displays of all types, for example backlit displays, in active or passive or non-luminescent displays (so-called “non-self-emitter” displays), for example LCD-TFTs. Mention can be made, for example of computer monitors, particularly TFT units, LCD displays, plasma displays, scanners, advertising signs, medical instruments, equipment for air and space operations, navigation technology, telephone displays, especially mobile telephone displays and PDA's (personal digital assistant). For these types of application such fluorescent lights have very small dimensions and accordingly, the lamp glass is of only a minimal thickness. Preferred displays, such as screens, are so-called flat displays as used in lap tops, especially flat backlight arrangements.

The design, the configuration and overall structure of the backlight systems in which the inventive EEFL-type fluorescent lamps can be utilized, is not limited according to the present invention. Any feasible backlight arrangement which is known may be utilized. Several backlight arrangements are described below, merely as examples. However, the present invention is not limited to these.

In a first variation of a backlight arrangement two or more fluorescent lamps can, for example, be located parallel to each other and are preferably located between a base or support plate and a cover or substrate plate or disk. One or more recesses are provided in the support plate in which the light device or devices are located. Preferably, one recess accommodates one fluorescent lamp. The light emitted from the fluorescent lamp(s) is reflected in the display or screen.

In accordance with this variation of the present invention, a reflective coating is advantageously applied on the reflective support plate, or particularly in the recess or recesses which, as a type of reflector uniformly disburses the light which radiates from the lamp in the direction of the support plate, thereby ensuring a homogenous illumination of the display or screen. Any desired plate or disc that would normally be utilized for this purpose may be used as a substrate or cover plate or disk which, depending upon the system configuration and purpose of application, would function as a light distributing device or merely as a cover. Accordingly, the substrate or cover plate or disk can be an opaque diffuser disk or a clear transparent disk.

The preferred use for this arrangement according to the first variation is for larger displays, for example televisions.

In accordance with a second variation for a possible backlight the fluorescent lamp may, for example, also be located outside of the light distribution device. Therefore, the light device or devices can, for example, be located on the outside on a display or screen, whereby the light is then released uniformly across the display or screen by way of a light transporting plate functioning as a light guide—a so-called (LGP). Such light transporting plates have a rough surface over which the light is released.

In a preferred embodiment of a third variation of a backlight system the light producing unit includes an enclosed chamber which is limited on top by a structured disk, below by a carrier plate as well as by walls on the sides. Fluorescent lamps are located on the sides of the unit. This enclosed chamber can be further subdivided into individual radiation chambers, which may contain a discharge luminous matter which, for example, is applied onto a carrier disc at a predetermined thickness. An opaque diffuser plate or a clear transparent disk or suchlike can again—depending upon system configuration—be utilized as the cover plate.

### BRIEF DESCRIPTION OF THE DRAWINGS

The invention is described in further detail below with the assistance of the enclosed drawing, FIG. 1:

FIG. 1 illustrates a schematic view of an embodiment of an EEFL-type fluorescent lamp of the present invention.

The exemplification set out herein illustrates one embodiment of the invention, in one form, and such exemplification is not to be construed as limiting the scope of the invention in any manner.

### DETAILED DESCRIPTION OF THE INVENTION

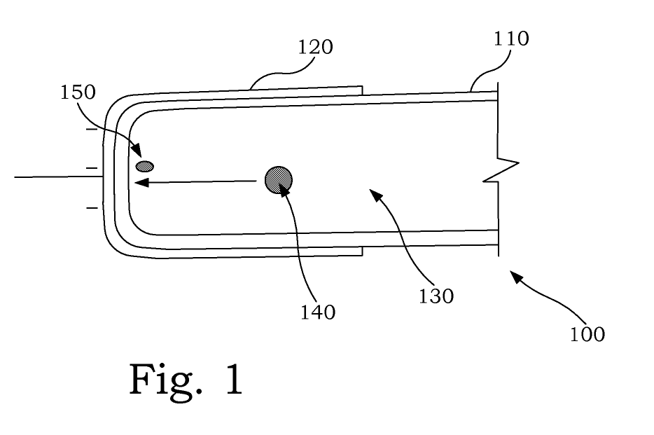

Referring now to FIG. 1, there is illustrated a fluorescent lamp of the present invention, especially a miniaturized fluorescent lamp 100, which is constructed from an encapsulating glass 110, a metal contact 120 which is, for example, provided in the form of an exterior metal cap, as well as a discharge gas 130 which is located inside EEFL-type fluorescent lamp 100. The gas mixture is utilized as a discharge gas 130. Consequently a capacitor is practically created in the interior of the encapsulating glass through which the electrical power is provided as alternating voltage. Encapsulating glass 110 serves not only as a dielectric in this capacitor, but its interior surface also assumes the additional function as a cathode material. An ion 140 from discharge gas 130 migrates to the interior surface of encapsulating glass 110, which functions as a cathode material, where it is neutralized. In accordance with the present invention, encapsulating glass 110 possesses at least one doping agent and/or an interior coating which contains at least one doping agent or consists of the same. Therefore, the emission of a secondary electron 150 is induced due to the regulated low work function Wₐ for the electrons. This may occur either from encapsulating glass 110 itself or from a coating (an interior coating) which was applied onto the encapsulating glass or from the coating and the encapsulating glass. Based on the doping of encapsulating glass 110 and/or the interior coating the probability of secondary electron 150 emission is increased when an ion 140 from glass plasma 130 is neutralized on the surface of the cathode. This allows for the operating efficiency of a fluorescent lamp to be set as high as possible. In addition it results in a clearly reduced firing voltage of the EEFL-type fluorescent lamp as compared to other EEFL-type fluorescent lamps known from the current state of the art.

In accordance with the present invention an optimized EEFL-type fluorescent lamp is provided whose encapsulating glass is doped either with a high earth alkali ion concentration or an aluminum composition and/or which includes at least one of the listed heavy metal elements and/or which is provided with an interior coating which contains or consists of at least one of the listed doping agents. By providing at least one doping agent in and/or on the interior surface of the encapsulating glass of an EEFL-type fluorescent lamp in a suitable quantity a high probability for the emission of secondary electrons can be provided due to the low work function Wₐ for electrons in the range of <6 eV, preferably <5 eV, especially preferably in the range of 0 eV<Wₐ<4 eV, more especially preferably 0 eV<Wₐ<3 eV. This presents the first time that a tailor made encapsulating glass for the optimum operation of an EEFL-type fluorescent lamp has been provided. In addition to being able to set a highest possible operating efficiency, the firing voltage of the lamp can also be successfully adjusted as low as possible. Due to a lower firing voltage, especially high voltages need no longer be utilized in flat screens thereby clearly reducing any safety risk. In addition, a higher efficiency is achieved, since the lag times are clearly reduced.

### CALCULATION EXAMPLE

Theoretical calculations of the work function of MgO and BaO single crystals follow:

In order to support the idea of high BaO and MgO containing glasses we calculate the work function for the crystalline surface of BaO and MgO single crystals. An excellent description on how to calculate the work function in detail is given in [H. D. Hagstrum, Phys. Rev. 122, 83, 1961]. Here we just refer to the single approximate relationship between work function Φ and the secondary electron emission coefficient γ.
γ˜Ei−2Φ (1)

where Ei is the ionization energy of the ions in the discharge plasma (e.g. Xe has an Eᵢ^{Xe} of 12.13 eV). This means a material with a low work function will show a large secondary electron emission rate, therefore a low firing voltage of the discharge lamp and a high efficiency. The work function is defined as the energy to move an electron from a bulk material over the surface into the surrounding vacuum. It can be calculated as the difference between the electron energy in the vacuum minus the Fermi energy inside the solid. Usually an ideal crystalline material is perfectly periodic in space with a periodicity of the lattice constant a. In the vicinity of a surface the structure is altered in mainly the first two or three atomic layers of the surface. The calculation is performed as follows and is implemented in the commercial density functional theory (DFT) packages VASP [G. Kresse, J. Furthmüller, Phys. Rev. B 54, 11169, 1996]. In a first step, for the ideal periodic crystal, the structural minimum is found by minimizing the total energy of the configuration with an approximate solution of the main body Schrödinger equation for electrons in the background of the positively charged atomic nuclei. In a second step a surface along a particular direction is formed by stacking a number of elementary cells in this direction on top of each other. Finally, a vacuum is added with a thickness much bigger than the length scale on which electronic wave functions decay. A thickness of 10 Å (=10⁻⁹ m) turns out to be sufficient. As a next step periodic boundary conditions are applied for the stack, which leads to a pair of surfaces along particular directions. After this, a structural relaxation of the atomic positions has to be performed. Finally the work function can be calculated as the difference between the vacuum electronic energy and the Fermi energy close to the surface. The method and its problems are also described in [S. Picozzi, R. Asahi, C. B. Geller, A. J. Freeman, Phys. Rev. Lett. 89, 197601, 2002]. The results for BaO and MgO are shown in table 1. They agree well with experiments [J. Y. Lim, J. S. Oh, B. D. Ko, J. W. Cho, S. O. Kang, G. Cho, H. S. Uhm, E. H. Choi, J. Appl. Phys. 94, 1, 2003] and explain the large secondary electron emission rates of MgO and BaO [E. H. Choi, J. Y. Lim, Y. G. Kim, J. J. Ko, D. I. Kim, C. W. Lee, G. Cho, J. Appl. Phys. 86, 6525, 1999]. However, the experiments are extremely difficult to perform. The reason is that surface charges build up on an insulator and the work function can only be asymptotically estimated from a number of experimental runs with different bombarding ions in the discharge plasma. Nevertheless, the experimental values measured in [J. Y. Lim, J. S. Oh, B. D. Ko, J. W. Cho, S. O. Kang. G. Cho, H. S. Uhm, E. H. Choi, J. Appl. Phys. 94, 1, 2003] for MgO single crystals, which are 4.22 eV for the (111)-direction, 4.94 eV for the (100)-direction and 5.07 eV for the (110)-direction, agree well with the calculated values of table 1. Therefore it is plausible that also the calculated values for BaO are reasonable.

TABLE 1
Calculated values of the work function for different crystal orientations

| Material | Surface normal | Work function/eV | Measurement ref.*/eV |
|---|---|---|---|
| BaO | (111) | 4.05 | |
| BaO | (100) | 4.31 | |
| BaO | (110) | 6.38 | |
| MgO | (111) | 6.82 | 4.22 |
| MgO | (100) | 4.54 | 5.07 |
| MgO | (110) | 5.23 | 4.94 |

*. . . [J. Y. Lim, J. S. Oh, B. D. Ko, J. W. Cho, S. O. Kang, G. Cho, H. S. Uhm, E. H. Choi, J. Appl. Phys. 94, January 2003]

Overall the calculated values agree well with the experimental ones of ref. [J. Y. Lim, J. S. Oh, B. D. Ko, J. W. Cho, S. O. Kang, G. Cho, H. S. Uhm, E. H. Choi, J. Appl. Phys. 94, 1, 2003].

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1-34. (canceled)

35. An External Electrode Fluorescent Lamp (EEFL) for backlighting of displays or screens, comprising:
an encapsulating glass, at least one of said encapsulating glass and an interior coating of said encapsulating glass having a work function Wₐ for electrons of <6 eV and containing at least one doping agent selected from at least one of a first group and a second group, said first group consisting of BaO, CaO, MgO, SrO, MgF₂, AlN, Al₂O₃ and Mg_{1-x-y}SrₓCa_{y}O in an amount in the range of 3 to 70 weight-%, said second group consisting of La₂O₃, Bi₂O₃, BaO and PbO in an amount in the range of 3 to 80 weight-%.

36. The EEFL of claim 35, wherein said weight-% of said first group is between 5 and 60 weight-%.

37. The EEFL of claim 35, wherein said weight-% of said second group is between 5 and 75 weight-%.

38. The EEFL of claim 35, wherein a sum of the amount of said doping agents from said first group and said second group present in the encapsulating glass has a lower limit and an upper limit, said lower limit being ≧15 weight-%, said upper limit being ≦80 weight-%.

39. The EEFL of claim 35, wherein said at least one doping agent is selected from at least one of said first group and said second group in an amount so that a secondary emission rate y>0.01 is achieved.

40. The EEFL of claim 35, wherein said interior coating has a large band gap of >4 eV so as to make said interior coating a fluorescent color.

41. The EEFL of claim 35, further comprising a gas mixture contained within said encapsulating glass, said gas mixture including neon.

42. The EEFL of claim 41, wherein a proportion of said neon in said gas mixture is in a range of 10-99% by volume.

43. The EEFL of claim 35, wherein said interior coating is applied to said encapsulating glass at a thickness of approximately 0.3 nm to approximately 10 μm.

44. The EEFL of claim 35, wherein the EEFL is used as a backlight of a backlight system of an electronic display.

45. The EEFL of claim 44, wherein said electronic display is one of active and passive.

46. The EEFL of claim 45, wherein said electronic display is included in one of a computer monitor, a TFT unit, an LCD display, a plasma display, a scanner, an advertising sign, a medical instrument, equipment for air and space operations, navigation technology, a telephone display, a mobile telephone display and a personal digital assistant.

47. An External Electrode Fluorescent Lamp (EEFL) glass, comprising:
an encapsulating glass, at least one of said encapsulating glass and an interior coating of said encapsulating glass having a work function Wₐ for electrons of <6 eV and containing at least one doping agent selected from at least one of a first group and a second group, said first group consisting of BaO, CaO, MgO, SrO, MgF₂, AlN, Al₂O₃ and Mg_{1-x-y}SrₓCa_{y}O in an amount in the range of 3 to 70 weight-%, said second group consisting of La₂O₃, Bi₂O₃, BaO and PbO in an amount in the range of 3 to 80 weight-%.

48. The EEFL glass of claim 47, wherein said weight-% of said first group is between 5 and 60 weight-%.

49. The EEFL glass of claim 47, wherein a sum of the amount of said doping agents from said first group and said second group present in the encapsulating glass has a lower limit and an upper limit, said lower limit being ≧15 weight-%, said upper limit being ≦80 weight-%.

50. The EEFL glass of claim 47, wherein said at least one doping agent is selected from at least one of said first group and said second group in an amount so that a secondary emission rate y>0.01 is achieved.

51. The EEFL glass of claim 47, wherein said interior coating has a large band gap of >4 eV so as to make said interior coating a fluorescent color.

52. The EEFL glass of claim 47, wherein said interior coating is applied to said encapsulating glass at a thickness of approximately 0.3 nm to approximately 10 μm.

53. The EEFL glass of claim 47, wherein said interior coating is applied to said encapsulating glass by a coating method, said coating method being at least one of sputtering, dipping, spraying or baking on of a coating material which consists of said at least one doping agent selected from at least one of said first group and said second group.

54. The EEFL glass of claim 53, wherein said coating is accomplished by dipping said encapsulating glass into a sludge with a powder consisting of at least one doping agent selected from at least one of said first group and said second group.

55. The EEFL glass of claim 53, wherein said coating is accomplished by spraying of an inside surface of said encapsulating glass with a sludge having a powder containing said at least one doping agent.

56. A device utilizing an encapsulating glass, the encapsulating glass comprising at least one doping agent in the encapsulating glass, said at least one doping agent selected from at least one of a first group and a second group, said first group consisting of BaO, CaO, MgO, SrO, MgF₂, AlN, Al₂O₃ and Mg_{1-x-y}SrₓCa_{y}O in an amount in the range of 3 to 70 weight-%, said second group consisting of La₂O₃, Bi₂O₃, BaO and PbO in an amount in the range of 3 to 80 weight-%, the encapsulating glass having a work function Wₐ for electrons of <6 eV.

57. The glass of claim 56, wherein said weight-% of said first group is between 5 and 60 weight-%.

58. The glass of claim 56, wherein said weight-% of said second group is between 5 and 75 weight-%.

59. The glass of claim 56, wherein the glass is used in an External Electrode Fluorescent Lamp (EEFL).

60. The glass of claim 56, wherein a sum of the amount of said doping agents from said first group and said second group present in the encapsulating glass has a lower limit and an upper limit, said lower limit being ≧15 weight-%, said upper limit being ≦80 weight-%.

61. A device utilizing an encapsulating glass with a partial interior coating, the interior coating comprising at least one doping agent, said at least one doping agent selected from at least one of a first group and a second group, said first group consisting of BaO, CaO, MgO, SrO, MgF₂, AlN, Al₂O₃ and Mg_{1-x-y}SrₓCa_{y}O in an amount in the range of 3 to 70 weight-%, said second group consisting of La₂O₃, Bi₂O₃, BaO and PbO in an amount in the range of 3 to 80 weight-%, the encapsulating glass having a work function Wₐ for electrons of <6 eV.

62. The interior coating of claim 61, wherein said weight-% of said first group is between 5 and 60 weight-%.

63. The interior coating of claim 61, wherein said weight-% of said second group is between 5 and 75 weight-%.

64. The interior coating of claim 61, wherein the interior coating is used in the encapsulating glass of an External Electrode Fluorescent Lamp (EEFL).

65. The interior coating of claim 61, wherein a sum of the amount of said doping agents from said first group and said second group present in the encapsulating glass has a lower limit and an upper limit, said lower limit being ≧15 weight-%, said upper limit being ≦80 weight-%.

66. The interior coating of claim 61, wherein said at least one doping agent is selected from at least one of said first group and said second group in an amount so that a secondary emission rate y>0.01 is achieved.

67. The interior coating of claim 61, wherein the interior coating has a large band gap of >4 eV, so as to make coating possible of a fluorescent color.

68. The interior coating of claim 61, wherein the interior coating is applied to the encapsulating glass at a thickness of approximately 0.3 nm to approximately 10 μm.

69. A method of producing an encapsulating glass comprising the steps of:
adding at least one doping agent to starting material for the encapsulating glass, said at least one doping agent selected from at least one of a first group and a second group, said first group consisting of BaO, CaO, MgO, SrO, MgF₂, AlN, Al₂O₃ and Mg_{1-x-y}SrₓCa_{y}O in an amount in the range of 3 to 70 weight-%, said second group consisting of La₂O₃, Bi₂O₃, BaO and PbO in an amount in the range of 3 to 80 weight-%, the encapsulating glass having a work function Wₐ for electrons of <6 eV; and
producing the encapsulating glass from said starting material.

70. The method of claim 69, wherein said weight-% of said first group is between 5 and 60 weight-%.

71. The method of claim 69, wherein said weight-% of said second group is between 5 and 75 weight-%.

72. A method of producing an interior coating comprising the steps of:
adding at least one doping agent to starting material for the interior coating, said at least one doping agent selected from at least one of a first group and a second group, said first group consisting of BaO, CaO, MgO, SrO, MgF₂, AlN, Al₂O₃ and Mg_{1-x-y}SrₓCa_{y}O in an amount in the range of 3 to 70 weight-%, said second group consisting of La₂O₃, Bi₂O₃, BaO and PbO in an amount in the range of 3 to 80 weight-%, the encapsulating glass having a work function Wₐ for electrons of <6 eV;
producing the interior coating from said starting material; and
applying said interior coating to a surface of an encapsulating glass.

73. The method of claim 72, wherein said weight-% of said first group is between 5 and 60 weight-%.

74. The method of claim 72, wherein said weight-% of said second group is between 5 and 75 weight-%.
